(19) United States
(12) Patent Application Publication
(10) Pub. No.: US 2025/0055090 A1
(43) Pub. Date: Feb. 13, 2025

(54) METHOD OF MANUFACTURING A POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yozo UCHIDA, Toyota-shi (JP); Yuki SATO, Toyota-shi (JP); Satoshi FUJIMURA, Toki-shi (JP); Nozomi TATEYAMA, Okazaki-shi (JP); Masahiro UCHIMURA, Miyoshi-shi (JP); Masataka ASAI, Toyota-shi (JP); Shigeru MATSUMOTO, Toyohashi-shi (JP); Yuki NAGAE, Toyohashi-shi (JP); Daisuke SUZUKI, Hamamatsu-shi (JP); Keitaro MACHIDA, Hamamatsu-shi (JP)

(21) Appl. No.: 18/613,125

(22) Filed: Mar. 22, 2024

(30) Foreign Application Priority Data
Aug. 11, 2023 (JP) 2023-131707

(51) Int. Cl. H01M 50/169; H01M 10/0525; H01M 50/103; H01M 50/15; H01M 50/188

(52) U.S. Cl. CPC H01M 50/169; H01M 10/0525; H01M 50/103; H01M 50/15; H01M 50/188

(57) ABSTRACT

A method of manufacturing a power storage device includes a laser welding step in which a laser beam is irradiated to an opening portion of a case body and a peripheral portion of a case lid member of a lid assembly over the entire circumference to laser weld them while the opening portion of the case body is closed by the case lid member, a shielding step, prior to the laser welding step, in which a shield member is placed in position on the lid assembly to prevent scattered light of the laser beam from reaching a resin member, and a removing step, after the laser welding step, in which the shield member is removed.

### CROSS-REFERENCE TO RELATED APPLICATIONS

This application is based upon and claims the benefit of priority to Japanese Patent Application No. 2023-131707 filed on Aug. 11, 2023, the entire contents of which are incorporated herein by reference.

### BACKGROUND

### Technical Field

This disclosure relates to a method of manufacturing a power storage device provided with a case having a case body and a case lid member welded thereto, a terminal member inserted in an insertion hole of the case lid member, and a resin member joined to an insertion hole surrounding portion of the case lid member and the terminal member while insulating between them to fix the terminal member to the case lid member.

### Related Art

As a power storage device, a prismatic battery has been known, in which a rectangular parallelepiped box-shaped case fixed with positive and negative terminal members via corresponding resin members. Specifically, the case is composed of a bottomed rectangular tube-like case body having a rectangular opening portion and a rectangular plate-like case lid member welded to the case body over the entire circumference while closing the opening portion. Further, the positive and negative terminal members are inserted in corresponding insertion holes provided in the case lid member and each extend from inside to outside of the case. Those positive and negative terminal members are fixed to the case lid member via the resin members hermetically joined to the terminal members while insulating between the positive and negative terminal members and the corresponding insertion hole surrounding portions of the case lid member. One example of the battery configured as above is disclosed in Japanese unexamined patent application publication No. 2022-079172 (JP 2022-079172A) (see FIGS. 1 and 2, and others).

### Technical Problems

The above-described battery is manufactured in the following manner. Specifically, the terminal members are fixed to the case lid member via the resin members by insert molding, swaging, and so on, to form a lid assembly with those members integrated together. Then, the opening portion of the case body is closed with the case lid member of the lid assembly, and the opening portion of the case body and the peripheral portion of the case lid member are welded together by laser, forming a case. Subsequently, an electrolyte is poured into the case. The battery is thus completed.

However, during the laser welding, scattered light of the laser beam may reach the resin member insulating between the case lid member and the terminal member, causing burning on some areas of the resin member, resulting in burned parts or burn marks thereat.

The present disclosure has been made to address the above problems and has a purpose to provide a method of manufacturing a power storage device, capable of suppressing the occurrence of burned parts on a resin member that insulates between an insertion hole surrounding portion of a case lid member and a terminal member, when a case body and the case lid member are laser-welded together to form a case.

### SUMMARY

(1) To achieve the above-mentioned purpose, one aspect of the present disclosure provides a method of manufacturing a power storage device comprising: a case having: a bottomed tube-shaped case body having an opening portion; and a case lid member having an insertion hole and being welded to the case body over its entire circumference while closing the opening portion; a terminal member inserted in the insertion hole of the case lid member; and a resin member joined to an insertion hole surrounding portion of the insertion hole of the case lid member and the terminal member while insulating between them to fix the terminal member to the case lid member, wherein the method comprises: laser-welding the opening portion of the case body and a peripheral portion of the case lid member over their entire circumference with a laser beam while the opening portion of the case body is closed with the case lid member that is a part of a lid assembly including the case lid member and the terminal member integrated via the resin member, to form the case; prior to laser-welding, shielding the resin member by placing a shield member on the lid assembly to block scattered light of the laser beam from reaching the resin member; and after laser-welding, removing the shield member.

In the above-described manufacturing method for the power storage device, prior to the laser welding process in which the case body and the case lid member are laser-welded to each other, the shielding process is performed to place the foregoing shield member on the lid assembly in advance. Thus, during laser welding in the laser welding process, the scattered light of the laser beam is less likely to reach the resin member by the presence of the shield member, suppressing the occurrence of burned parts on the resin member.

The “power storage device” may include, for example, a secondary battery, such as a lithium-ion secondary battery, a sodium-ion secondary battery, and a calcium-ion secondary battery, and a capacitor, such as a lithium-ion capacitor.

The “shield member” may include, for example, a shield member made of metal and a shield member made of ceramic. The shield member may be configured to cover the entirety of the resin outside portion of the resin member, located outside in a lid thickness direction of the case lid member or cover only a part of the resin outside portion. Alternatively, the shield member may be formed like a wall, i.e., a partitioned wall, placed between the resin member and the peripheral portion of the case lid member.

The “resin member” may be a resin member molded with the terminal member inserted in the insertion hole of the case lid member or alternatively may be made separately from the case lid member and the terminal member and fixed by caulking to the case lid member by the terminal member.
(2) In the method of manufacturing the power storage device described in (1), the laser beam has a wavelength of 0.5 μm or more, and a part of the shield member, where the scattered light of the laser beam reaches, has an Ag-plated layer.

Silver (Ag) hardly absorbs a laser beam with a wavelength of 0.5 μm or more compared to iron (Fe) and aluminum (Al), and is unlikely to be melted by scattered light of the laser beam even when reaches the silver. Therefore, when the part of the shield member, where the scattered light of the laser beam reaches, is coated with the Ag-plated layer as described above, the shield member is not easily melted by the scattered light of the laser beam and hence this shield member can be repeatedly utilized.
(3) In the method of manufacturing the power storage device described in (1), the laser beam has a wavelength of 0.9 μm or more, and a part of the shield member, where the scattered light of the laser beam reaches, is made of Cu.

Cupper (Cu) hardly absorbs a laser beam with a wavelength of 0.9 μm or more compared to Fe and Al, and is unlikely to be melted even when the scattered light of the laser beam reaches the cupper. Therefore, when the part of the shield member, where the scattered light of the laser beam reaches, is made of Cu, the shield member is not easily melted by the scattered light of the laser beam and hence the shield member can be repeatedly utilized.
(4) In the method of manufacturing the power storage device described in any one of (1) to (3), the shield member is configured to be removably fixed to the resin member or the terminal member, which is a part of the lid assembly.

Since the shield member is configured to be removably fixed as described above, the shield member can be temporarily fixed to the resin member or the terminal member by itself. This configuration can prevent the shield member from shifting from its predetermined position on the lid assembly or separating from the lid assembly, for example during transportation of the lid assembly with the shield member placed thereon. Thus, the lid assembly with the shield member placed thereon can be easily handled.
(5) In the method of manufacturing the power storage device described in (4), the shield member is made by bending a metal plate.

The shield member is made of a bent metal plate, resulting in an inexpensive shield member.
(6) In the method of manufacturing the power storage device described in any one of the foregoing configurations (1) to (5), the power storage device may be configured such that the case lid member has a rectangular plate shape extending in a lid longitudinal direction, a resin outside portion of the resin member, located outside in a lid thickness direction of the case lid member, has a rectangular plate-like outer shape, and includes a top surface facing outside in the lid thickness direction, a pair of long side surfaces extending along the lid longitudinal direction and facing mutually opposite sides in a lid short-side direction, and a pair of short side surfaces extending along the lid short-side direction and facing mutually opposite sides in the lid longitudinal direction, and the shield member is configured to prevent the scattered light of the laser beam from reaching the paired long side surfaces of the resin member.

Since the case lid member has a rectangular plate shape extending in the lid longitudinal direction, and the resin outside portion of the resin member has the top surface, paired long side surfaces, and paired short side surfaces, the distance from an irradiation site of a laser beam to the long side surface of the resin member tends to be short. Thus, the scattered light with high intensity easily reaches the long side surface of the resin member, which is likely to cause burning on some areas of the long side surface. In contrast, in the aforementioned manufacturing method, the shield member is configured to prevent the scattered light of the laser beam from reaching the pair of long side surfaces of the resin member. This configuration can suppress the occurrence of burned parts on the long side surface of the resin member.
(7) In the method of manufacturing the power storage device described in (6), the shield member may be configured to be longer in the lid longitudinal direction than the long side surface of the resin member.

Since the shield member has a longer shape in the lid longitudinal direction than the long side surface of the resin member, this shield member can appropriately prevent the scattered light of the laser beam from reaching the long side surface of the resin member in the laser welding process. This configuration and can also appropriately suppress the occurrence of burned parts on the long side surface of the resin member.

### BRIEF DESCRIPTION OF THE DRAWINGS

FIG. 1 is a perspective view of a battery in an embodiment;

FIG. 2 is a partially-broken cross-sectional view of the battery taken along a battery height direction and a battery width direction in the embodiment;

FIG. 3 is a partially-enlarged cross-sectional view of the battery, near a resin member, taken along the battery height direction and the battery width direction in the embodiment;

FIG. 4 is a flowchart of a method of manufacturing the battery in the embodiment;

FIG. 5 is an explanatory view showing a lid assembly in relation to the battery manufacturing method in the embodiment;

FIG. 6 is a perspective view of a shield member in relation to the battery manufacturing method in the embodiment;

FIG. 7A is an explanatory view showing a state where a shield member is placed on a lid assembly in a shielding step, as viewed in a lid short-side direction, in relation to the battery manufacturing method in the embodiment;

FIG. 7B is an explanatory view showing a state where the shield member is placed on the lid assembly in the shielding step, as viewed in a lid longitudinal direction, in relation to the battery manufacturing method in the embodiment; and

FIG. 8 is an explanatory view showing how to laser-weld an opening portion of a case body and a peripheral portion of the case lid member in a laser welding step while the shield member is placed in position, in relation to the battery manufacturing method in the embodiment.

### DETAILED DESCRIPTION OF THE EXEMPLARY EMBODIMENTS

### Embodiments

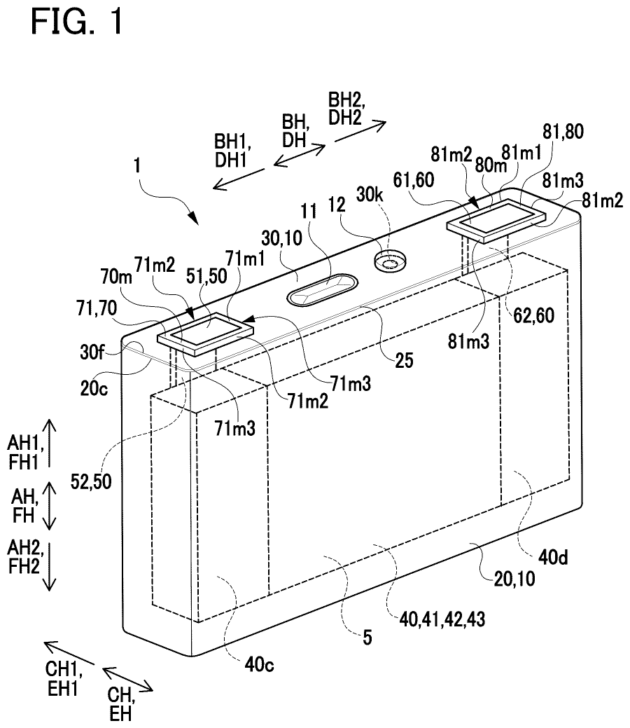

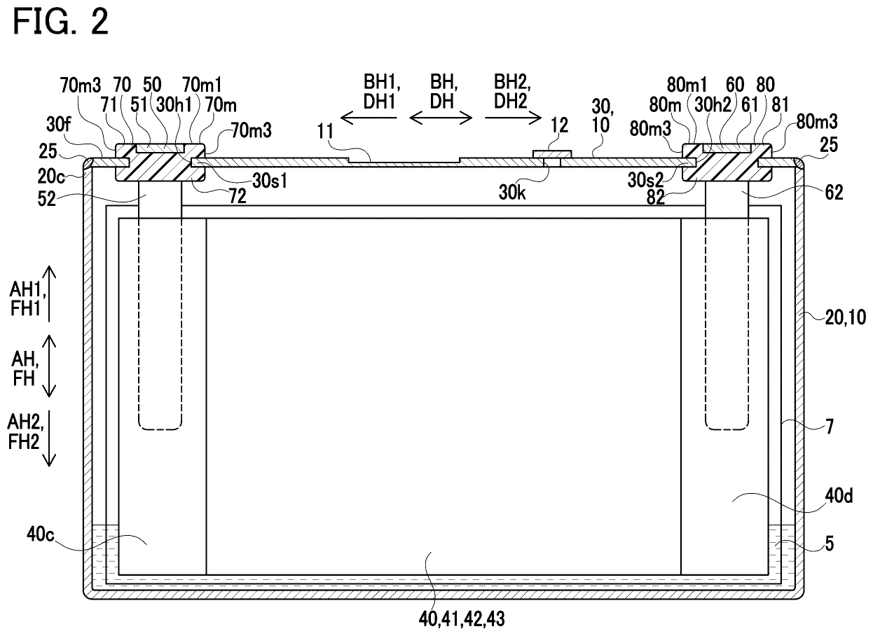

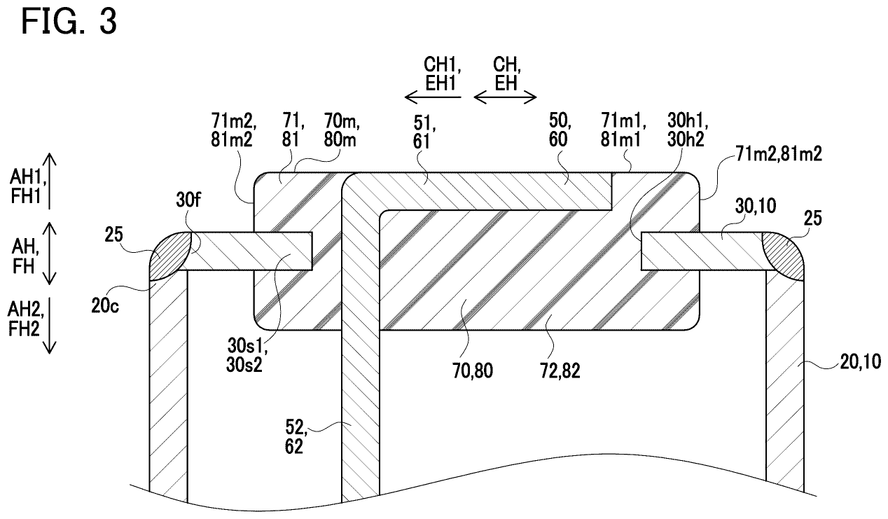

A detailed description of embodiments of this disclosure will now be given referring to the accompanying drawings. FIG. 1 is a perspective view of a battery 1 in the present embodiment, which is one example of a power storage device of the disclosure. FIG. 2 is a partially-broken cross-sectional view of the battery 1. FIG. 3 is a partially-enlarged cross-sectional view of the battery 1, near resin members 70 and 80. In the following description, the battery height direction AH, battery width direction BH, battery thickness direction CH of the battery 1, the lid longitudinal direction DH, lid short-side direction EH, and lid thickness direction FH of a case lid member 30 are defined as indicated by arrows in FIGS. 1 to 3.

The battery 1 is a prismatic (i.e., rectangular parallelepiped-shaped) sealed lithium-ion secondary battery which will be installed in a vehicle, such as a hybrid vehicle, a plug-in hybrid vehicle, and an electric vehicle. This battery 1 is composed of a case 10, an electrode body 40 housed in the case 10, a positive terminal member 50 fixed to the case 10 via the resin member 70, a negative terminal member 60 fixed to the case 10 via the resin member 80, and others. In the case 10, the electrode body 40 is covered with a pouch-shaped insulating holder 7 made of an insulating film. In addition, the case 10 contains an electrolyte 5, part of which is impregnated in the electrode body 40 and the rest is accumulated on the bottom wall of the case 10.

The case 10 is shaped like a rectangular box, made of metal (aluminum in this embodiment), and includes a case body 20 having a bottomed rectangular tube-like shape with a rectangular opening portion 20c, in which the electrode body 40 is housed, and the case lid member 30 having a rectangular plate-like shape that closes the opening portion 20c of the case body 20. The opening portion 20c of the case body 20 and a peripheral portion 30f of the case lid member 30 are hermetically welded to each other over the entire circumference thereof, forming a melt-solidified portion 25 across the case body 20 and the case lid member 30.

The case lid member 30 of the case 10 is provided with a safety valve 11 that can break open when the internal pressure of the case 10 exceeds a valve opening pressure. The case lid member 30 is provided with a liquid inlet 30k that penetrates through the case lid member 30 in the lid thickness direction FH. This liquid inlet 30k is hermetically sealed with a circular disc-shaped sealing member 12 made of aluminum.

The electrode body 40 housed in the case 10 is a stacked-type electrode body having a rectangular parallelepiped shape and consisting of multiple positive electrode plates 41 and multiple negative electrode plates 42, which are alternately stacked with separators 43 each made of a porous resin film and interposed one by one therebetween, in the battery thickness direction CH. The positive electrode plates 41, the negative electrode plates 42, and the separators 43 are each of a rectangular shape extending in the battery height direction AH and the battery width direction BH.

The positive electrode plates 41 each include a positive current collecting foil made of an aluminum foil and positive active material layers, each of which contains positive active material particles and is formed on each principal surface of this foil. Part of the positive current collecting foil extends out on one side BH1 in the battery width direction BH, forming a positive electrode foil exposed portion, both surfaces of which are exposed without positive active material layers. The positive electrode foil exposed portions of the positive electrode plates 41 are stacked in its foil thickness direction, forming a positive current collector 40c. This positive current collector 40c is electrically connected to the positive terminal member 50 mentioned later.

The negative electrode plates 42 each include a negative current collecting foil made of a copper foil and negative active material layers, each of which contains negative active material particles and is formed on each principal surface of this foil. Part of the negative current collecting foil extends out on the other side BH2 in the battery width direction BH, forming a negative electrode foil exposed portion, both surfaces of which are exposed without having negative active material layers. The negative electrode foil exposed portions of the negative electrode plates 42 are stacked in its foil thickness direction, forming a negative current collector 40d. This negative current collector 40d is electrically connected to the negative terminal member 60 mentioned later.

In the case lid member 30, near the ends on one side DH1 and the other side DH2 in the lid longitudinal direction DH, i.e., the one side BH1 and the other side BH2 in the battery width direction BH, rectangular insertion holes 30h1 and 30h2 are provided penetrating through the case lid member 30 in the lid thickness direction FH. In the insertion hole 30h1, the positive terminal member 50 made of aluminum is inserted. This terminal member 50 is fixed to the case lid member 30 while being insulated from the case lid member 30 via the resin member 70. In the other insertion hole 30h2, the negative terminal member 60 made of copper is inserted. This terminal member 60 is fixed to the case lid member 30 while being insulated from the case lid member 30 via the resin member 80.

The terminal members 50 and 60 are each made of a metal plate (an aluminum plate for positive electrode and a copper plate for negative electrode) by press working. Please note that the terminal members 50 and 60 are identical in configuration and thus only the terminal member 50 is described below with relevant referential signs, followed by the referential signs for the terminal member 60 in parentheses. The terminal member 50 (60) includes a terminal top plate portion 51 (61), having a rectangular plate-like shape and being located on the outside FH1 in the lid thickness direction FH of the case lid member 30, i.e., on the upper side AH1 in the battery height direction AH, and extending in the lid longitudinal direction DH and the lid short-side direction EH, i.e., the battery width direction BH and the battery thickness direction CH, and a terminal extending portion 52 (62) extending from the terminal top plate portion 51 (61) to the inside FH2 in the lid thickness direction FH, i.e., to the lower side AH2 in the battery height direction AH. The terminal extending portion 52 (62) is bent at an end on one side EH1 in the lid short-side direction EH, i.e., one side CHI in the battery thickness direction CH, to extend to the inside FH2 in the lid thickness direction FH by passing through the insertion hole 30h1 (30h2) and further extend to the lower side AH2 by penetrating through the resin member 70 (80). The positive terminal extending portion 52 is welded, at its distal end portion on the lower side AH2, to the positive current collector 40c of the electrode body 40 and electrically connected thereto. Further, the negative terminal extending portion 62 is welded, at its distal end portion on the lower side AH2, to the negative current collector 40d of the electrode body 40 and electrically connected thereto.

Next, the resin members 70 and 80 will be described below. Please note that the resin members 70 and 80 are similar in configuration and therefore only the resin member 70 is described below with relevant reference signs, followed by corresponding referential signs for the resin member 80 in parentheses. The resin member 70 (80) is made by insert-molding of a resin material including a thermoplastic main resin (specifically, polyphenylene sulfide (PPS)), a thermoplastic elastomer, and filler (specifically, fibrous glass filler). The resin member 70 (80) is hermetically joined to both an insertion hole surrounding portion 30s1 (30s2) of the case lid member 30, located surrounding the insertion hole 30h1 (30h2), and the terminal member 50 (60), while insulating between the insertion hole surrounding portion 30s1 (30s2) and the terminal member 50 (60), to fix the terminal member 50 (60) to the case lid member 30.

The resin member 70 (80) includes a resin outside portion 71 (81) located on the outside FH1 in the lid thickness direction FH of the case lid member 30, and a resin inside portion 72 (82) located in the insertion hole 30h1 (30h2) of the case lid member 30 and on the inside FH2 in the lid thickness direction FH of the case lid member 30 and integrally connected to the resin outside portion 71 (81).

The resin outside portion 71 (81) has a rectangular ring-shaped top surface 71m1 (81m1) having a rectangular plate-like outer shape and facing the outside FH1 in the lid thickness direction FH, a pair of rectangular long side surfaces 71m2 (81m2) extending in the lid longitudinal direction DH and facing the mutually opposite sides in the lid short-side direction EH, and a pair of rectangular short side surfaces 71m3 (81m3) extending in the lid short-side direction EH and facing the mutually opposite sides in the lid longitudinal direction DH. An outer surface 70m (80m) exposed to the outside of the case 10, as a part of the resin member 70 (80), is constituted of those top surface 71m1 (81m1), paired long side surfaces 71m2 (81m2), and paired short side surfaces 71m3 (81m3). In the battery 1 in the embodiment, there is no burned part on any areas of the outer surface 70m (80m) of the resin member 70 (80), i.e., the top surface 71m1 (81m1), long side surfaces 71m2 (81m2), and short side surfaces 71m3 (81m3).

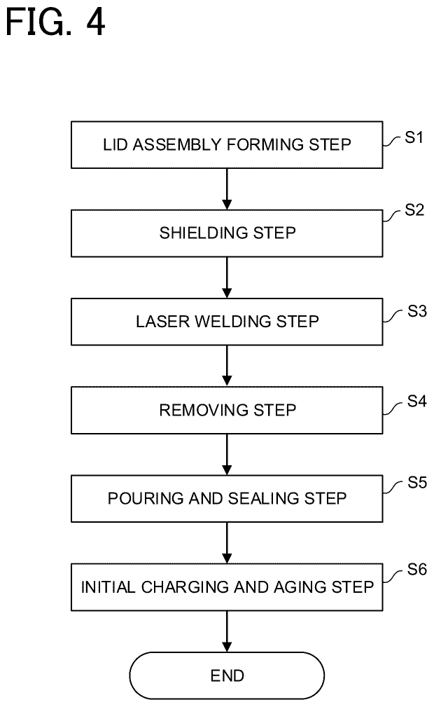

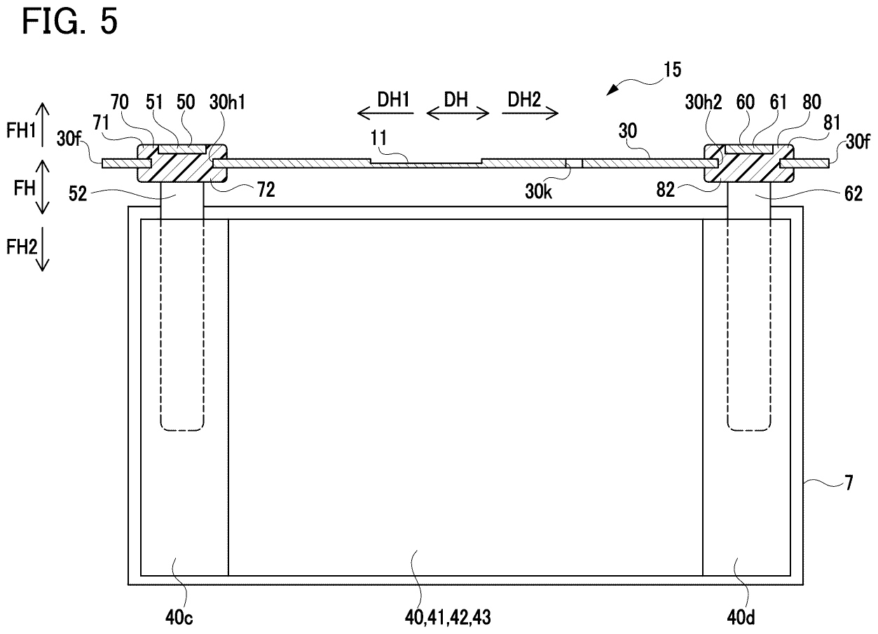

Next, a method of manufacturing the battery 1 will be described below, referring to FIGS. 4 to 8. In a lid assembly forming step S1 (see FIG. 4), a lid assembly 15 is formed first, as shown in FIG. 5. Specifically, the case lid member 30 and the terminal members 50 and 60 are prepared, and the resin members 70 and 80 are made by insert molding with those members 30, 50, and 60 inserted in place to fix the terminal member 50 and the terminal member 60 to the case lid member 30 via the resin member 70 and the resin member 80 respectively. The case lid member 30 is made by punching an aluminum plate into a predetermined shape and forming therein the liquid inlet 30k, insertion holes 30h1 and 30h2, and safety valve 11. The positive terminal member 50 is made by punching an aluminum plate into a predetermined shape and further bending this plate. The negative terminal member 60 is made by punching a copper plate into a predetermined shape and further bending this plate.

While the terminal members 50 and 60 are respectively inserted in the insertion holes 30h1 and 30h2 of the case lid member 30, the resin members 70 and 80 are made by insert-molding of the foregoing resin material to fix the terminal members 50 and 60 to the case lid member 30 via the resin members 70 and 80, respectively as shown in FIG. 5.

Then, the electrode body 40 is prepared, comprising the positive electrode plates 41, negative electrode plates 42, and separators 43 stacked on top of each other. The terminal extending portion 52 of the positive terminal member 50 is welded to the positive current collector 40c of the electrode body 40, while the terminal extending portion 62 of the negative terminal member 60 is welded to the negative current collector 40d of the electrode body 40. Thereafter, this electrode body 40 is wrapped with the pouch-shaped insulating holder 7. Thus, the lid assembly 15 is completed, including the case lid member 30, terminal members 50 and 60, resin members 70 and 80, electrode body 40, and insulating holder 7.

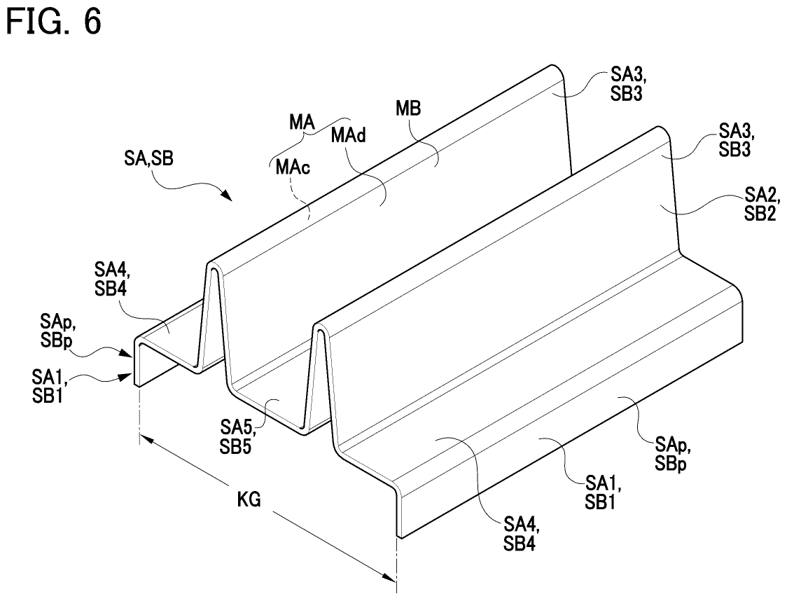

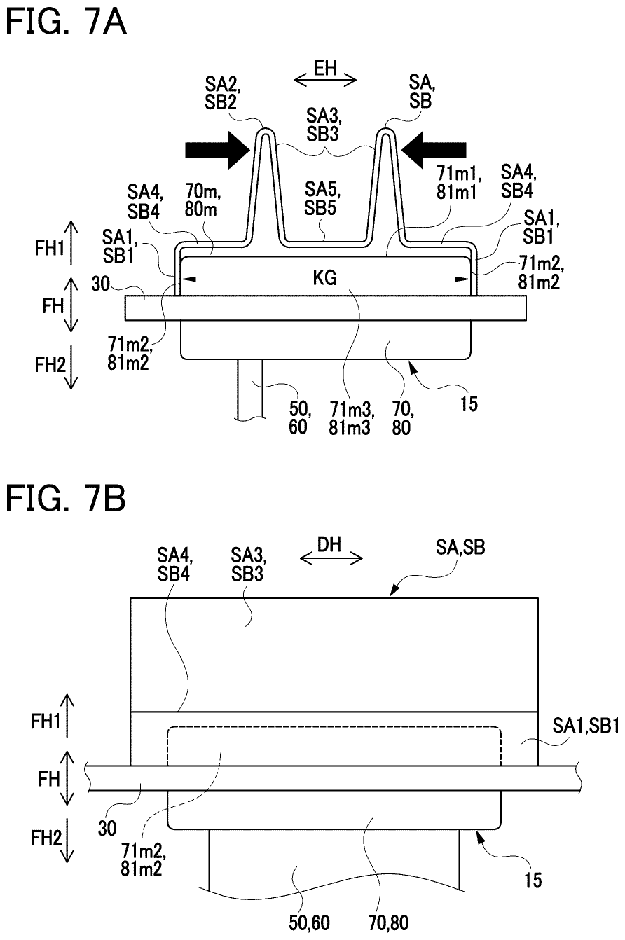

In a shielding step S2 (see FIG. 4) following the lid assembly forming step S1, a shield member SA is placed in position on the lid assembly 15, as shown in FIGS. 6, 7A and 7B, to shield the resin member 70, 80 to block scattered light LB of the laser beam LC from reaching the resin member 70, 80 in a laser welding step S3 mentioned later. This shield member SA will be described first. The shield member SA is made by bending a rectangular metal plate MA, which is a stainless steel plate MAc with an Ag-plated layer MAd formed over the entire surface thereof. In the shield member SA in the embodiment, therefore, the whole surface of the shield member SA has the Ag-plated layer MAd, including a part SAp where the scattered light LB of the laser beam LC reaches in the laser welding step S3 mentioned later.

This shield member SA is configured to be removably fixed to the resin member 70 (80) of the lid assembly 15. The shield member SA is configured to prevent the scattered light LB of the laser beam LC from reaching the paired long side surfaces 71m2 (81m2) of the resin member 70 (80), and further configured to be longer in the lid longitudinal direction DH than the long side surface 71m2 (81m2) of the resin member 70 (80). Specifically, the shield member SA includes a pair of side wall portions SA1 for covering the paired long side surfaces 71m2 (81m2) of the resin member 70 (80), and a connecting portion SA2 connecting the side wall portions SA1 to each other and being placed over the top surface 71m1 (81m1) of the resin member 70 (80) on the outside FH1 in the lid thickness direction FH.

The side wall portions SA1 are configured to cover the whole areas of the long side surfaces 71m2 (81m2) of the resin member 70 (80) and have a longer length in the lid longitudinal direction DH than the length of corresponding long side surfaces 71m2 (81m2) in the lid longitudinal direction DH, as shown in FIG. 7B.

The connecting portion SA2 is bent at more than one place to have two protruding portions SA3 each protruding in an inverted V-shape toward the outside FH1 in the lid thickness direction FH, a pair of first planar portions SA4 respectively connecting the side wall portions SA1 to the protruding portions SA3, and a second planar portion SA5 connecting the two protruding portions SA3. The first planar portions SA4 and the second planar portion SA5 each have a rectangular plate-like shape along the top surface 71m1 (81m1) of the resin member 70 (80).

This shield member SA is configured such that when the two protruding portions SA3 are pressed in a direction to come close to each other as indicated with arrows in FIG. 7A, the gap KG between the side wall portions SA1 widens to become larger than the length of the resin member 70 (80) in the lid short-side direction EH. On the other hand, when the above-mentioned pressure is released, the gap KG between the side wall portions SA1 narrows to become smaller than the length of the resin member 70 (80) in the lid short-side direction EH,

In the shielding step S2, therefore, while the two protruding portions SA3 of the shield member SA are pressed in the direction to come close to each other, widening the gap KG between the side wall portions SA1, the shield member SA is placed over the resin member 70 (80). Then, when the above-mentioned pressure is released, narrowing the gap KG between the side wall portions SA1, the paired side wall portions SA1 elastically grasp the resin member 70 (80) in the lid short-side direction EH. Thus, the shield member SA is temporarily fixed to the resin member 70 (80) of the lid assembly 15.

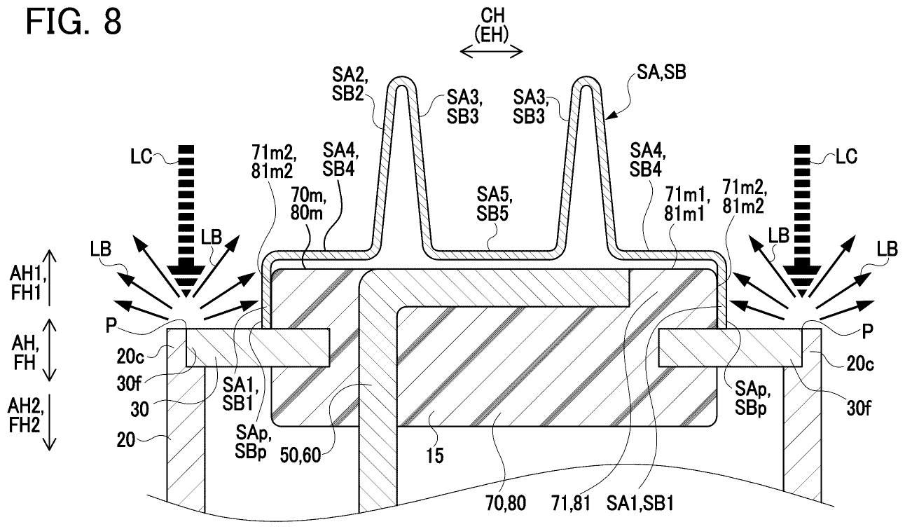

In the laser welding step S3 (see FIG. 4), subsequently, the case body 20 is prepared. The electrode body 40 covered with the insulating holder 7, as part of the lid assembly 15 described as above, is inserted into the case body 20. The case lid member 30 is then disposed to close the opening portion 20c of the case body 20 as shown in FIG. 8. The laser beam LC is applied to the opening portion 20c of the case body 20 and the peripheral portion 30f of the case lid member 30 over the entire circumference to hermetically laser-weld them. Thus, the case 10 is formed with the electrode body 40 housed therein.

Specifically, laser welding using a fiber laser is performed by applying the laser beam LC with a wavelength λ of 1.06 μm from the outside FH1 in the lid thickness direction FH of the case lid member 30 to the opening portion 20c of the case body 20 and the peripheral portion 30f of the case lid member 30 over the entire circumference, melting the irradiated sites of the opening portion 20c and the peripheral portion 30f, so that the melted portions are then mixed together and solidified to form the melt-solidified portion 25. Thus, the case 10 is completed.

During this laser welding, in the conventional method, the scattered light LB of the laser beam LC, radiated from an irradiation site P, easily directly reach a part of the outer surface 70m (80m) of the resin member 70 (80), i.e., the paired long side surfaces 71m2 (81m2) and paired short side surfaces 71m3 (81m3), which is likely to cause burning on some areas of the long side surfaces 71m2 (81m2) and the short side surfaces 71m3 (81m3). Especially, each long side surface 71m2 (81m2) is located close to the irradiation site P of the laser beam LC and thus the scattered light LB with high intensity reaches the long side surface 71m2 (81m2), so that burned parts are apt to occur thereat.

In the embodiment, in contrast, the shield member SA covers part of the outer surface 70m (80m) of the resin member 70 (80), i.e., the top surface 71m1 (81m1) and the paired long side surfaces 71m2 (81m2). Thus, the scattered light LB of the laser beam LC does not reach the top surface 71m1 (81m1) and the paired long side surfaces 71m2 (81m2) of the outer surface 70m (80m) of the resin member 70 (80), so that it is possible to prevent the occurrence of burning on any areas of the top surface 71m1 (81m1) and the paired long side surfaces 71m2 (81m2).

The paired short side surfaces 71m3 (81m3) of the outer surface 70m (80m) of the resin member 70 (80) are not covered by the shield member SA. However, the short side surfaces 71m3 (81m3) are sufficiently apart from the irradiation site P where the laser beam LC is irradiated, and the high-intensity scattered light LB does not reach the short side surfaces 71m3 (81m3) even when these short side surfaces 71m3 (81m3) are not covered with the shield member SA, so that burned parts do not occur in any areas of the paired short side surfaces 71m3 (81m3). Consequently, no burned parts are generated on any areas of the outer surface 70m (80m) of the resin member 70 (80), i.e., the top surface 71m1, paired long side surfaces 71m2 (81m2), and paired short side surfaces 71m3 (81m3).

In a removing step S4 (see FIG. 4), the shield member SA is removed. Specifically, the two protruding portions SA3 of the shield member SA are pressed in a direction to come close to each other, widening the gap KG between the side wall portions SA1, and this shield member SA is lifted up. Thus, the shield member SA is easily removed from the resin member 70 (80) and the lid assembly 15.

In a pouring and sealing step S5 (see FIG. 4), the electrolyte 5 is poured into the case 10 through the liquid inlet 30k so that the electrode body 40 is impregnated with the electrolyte 5. Then, the liquid inlet 30k is covered from outside with the sealing member 12. The sealing member 12 is then hermetically laser-welded to the case 10.

In an initial charging and aging step S6, subsequently, this battery 1 is connected to a charging device (not shown) and initially charged. Thereafter, the initially charged battery 1 is left to stand for a predetermined time for aging. In this way, the battery 1 is completed.

As described above, in the manufacturing method for the battery 1, the laser welding step S3 is performed while the shield member SA is placed in position on the lid assembly 15, so that the scattered light LB of the laser beam LC is less likely to reach the resin member 70 (80), preventing the occurrence of burned parts on the resin member 70 (80).

In the embodiment, furthermore, the part SAp of the shield member SA, where the scattered light LB of the laser beam LC reaches, is provided with the Ag-plated layer MAd. This Ag-plated layer MAd is less likely to absorb a laser beam LC with a wavelength λ of 0.5 μm or more and is hardly melted even when the scattered light LB of the laser beam LC reaches the Ag-plated layer MAd. Thus, the shield member SA is less likely to be melted by the scattered light LB of the laser beam LC and hence this shield member SA can be repeatedly utilized.

The shield member SA is configured to be removably fixed to the resin member 70 (80) of the lid assembly 15. Accordingly, the shield member SA can be temporarily fixed to the resin member 70 (80), i.e., to the lid assembly 15 by itself. This configuration can prevent the shield member SA from shifting from its predetermined position on the lid assembly 15 or separating from the lid assembly 15, for example even transport of the lid assembly 15 with the shield member SA placed thereon. Therefore, the lid assembly 15 with the shield member SA placed thereon can be easily handled. Furthermore, the shield member SA is made by bending the metal plate MA and therefore is inexpensive.

In the embodiment, the case lid member 30 has a rectangular plate-like shape extending in the lid longitudinal direction DH. The resin outside portion 71 (81) of the resin member 70 (80) has a rectangular plate-like shape including the top surface 71m1 (81m1), the paired long side surfaces 71m2 (81m2), and the paired short side surfaces 71m3 (81m3), and each long side surface 71m2 (81m2) of the resin member 70 (80) is located at a short distance from the irradiation site P where the laser beam LC is irradiated. Accordingly, the high-intensity scattered light LB easily reaches the long side surface 71m2 (81m2) of the resin member 70 (80), which is apt to cause burning on some areas of the long side surface 71m2 (81m2). In contrast, in the embodiment, the shield member SA is configured to block the scattered light LB from reaching the paired long side surfaces 71m2 (81m2) of the resin member 70 (80), and therefore can prevent the occurrence of burned parts on the long side surfaces 71m2 (81m2) of the resin member 70 (80).

Moreover, the shield member SA is longer in the lid longitudinal direction DH than the long side surfaces 71m2 (81m2) of the resin member 70 (80). This configuration can appropriately prevent the scattered light LB of the laser beam LC from reaching the long side surfaces 71m2 (81m2) of the resin member 70 (80) in the laser welding step S3, and thus can reliably prevent the occurrence of burned parts on any areas of the long side surfaces 71m2 (81m2) of the resin member 70 (80).

### Modified Example

Next, a modified example of the foregoing embodiment will be described below. The description of similar or identical configurations to those in the embodiment will be omitted or simplified. The shield member SA used in the embodiment has the Ag-plated layer MAd over the entire surface of the shield member SA including the part SAp where the scattered light LB of the laser beam LC reaches. In contrast, a shield member SB used in this modified example differs from the shield member SA in that the shield member SB including a part SBp where the scattered light LB of the laser beam LC reaches is entirely made of copper (Cu).

Specifically, the shield member SB in the modified example is made by bending a metal plate MB made of copper. However, the shape of the shield member SB is the same as that of the shield member SA in the embodiment. That is, the shield member SB, as with the shield member SA, consists of a pair of side wall portions SB1 and a connecting portion SB2 (i.e., two protruding portions SB3 and a pair of first planar portion SB4 and a second planar portion SB5). Thus, the shield member SB in the modified example can also be handled in the same manner as the shield member SA in the embodiment.

Even when the battery 1 is manufactured using this shield member SB, during laser welding in the laser welding step S3, the scattered light LB of the laser beam LC is also less likely to reach the resin member 70 (80) by the shield member SB. This can prevent the occurrence of the burned parts on any areas of the resin member 70 (80).

Further, as a part of the shield member SB, the part SBp where the scattered light LB of the laser beam LC reaches is made of Cu. Accordingly, the shield member SB is less likely to be melted by the scattered light LB of the laser beam LC, and thus the shield member SB can be repeatedly utilized. Other parts similar to the embodiments have the same effects as the embodiments.

The disclosure is described in the foregoing embodiment and modified example, but is not limited thereto. The disclosure may be embodied in other specific forms without departing from the essential characteristics thereof.

For instance, the shield members in the foregoing embodiment and modified example are exemplified by the shield members SA and SB configured to be removably fixed to the resin member 70 (80) of the lid assembly 15, but are not limited thereto. For example, when the terminal member has a terminal protruding portion that protrudes more outside in the lid thickness direction than the resin member, the shield member may be configured to be removably placed on the terminal protruding portion of the terminal member of the lid assembly.

### REFERENCE SIGNS LIST

1 Battery (Power storage device)
10 Case
15 Lid assembly
20 Case body
20c Opening portion
30 Case lid member
30f Peripheral portion
30h1, 30h2 Insertion hole
30s1, 30s2 Insertion hole surrounding portion
40 Electrode body
50, 60 Terminal member
70, 80 Resin member
SA, SB Shield member
SAp, SBp Part (of a shield member where scattered light of laser beam reaches)
SA1, SB1 Side wall portion
SA2, SB2 Connecting portion
SA3, SB3 Protruding portion
SA4, SB4 First planar portion
SA5, SB5 Second planar portion
KG Gap (between side wall portions)
MA, MB Metal plate
MAc Stainless steel plate
MAd Ag-plated layer
LC Laser beam
LB Scattered light
P Irradiation site
S1 Lid assembly forming step
S2 Shielding step
S3 Laser welding step
S4 Removing step

What is claimed is:

1. A method of manufacturing a power storage device comprising:
a case having:
a bottomed tube-shaped case body having an opening portion; and
a case lid member having an insertion hole and being welded to the case body over its entire circumference while closing the opening portion;
a terminal member inserted in the insertion hole of the case lid member; and
a resin member joined to an insertion hole surrounding portion of the insertion hole of the case lid member and the terminal member while insulating between them to fix the terminal member to the case lid member,
wherein the method comprises:
laser-welding the opening portion of the case body and a peripheral portion of the case lid member over their entire circumference with a laser beam while the opening portion of the case body is closed with the case lid member that is a part of a lid assembly including the case lid member and the terminal member integrated via the resin member, to form the case;
prior to laser-welding, shielding the resin member by placing a shield member on the lid assembly to block scattered light of the laser beam from reaching the resin member; and
after laser-welding, removing the shield member.

2. The method of manufacturing a power storage device according to claim 1,
wherein the laser beam has a wavelength of 0.5 μm or more, and
wherein a part of the shield member, where the scattered light of the laser beam reaches, has an Ag-plated layer.

3. The method of manufacturing a power storage device according to claim 1,
wherein the laser beam has a wavelength of 0.9 μm or more, and
wherein a part of the shield member, where the scattered light of the laser beam reaches, is made of Cu.

4. The method of manufacturing a power storage device according to claim 1, wherein the shield member is configured to be removably fixed to the resin member or the terminal member, which is a part of the lid assembly.

5. The method of manufacturing a power storage device according to claim 2, wherein the shield member is configured to be removably fixed to the resin member or the terminal member, which is a part of the lid assembly.

6. The method of manufacturing a power storage device according to claim 3, wherein the shield member is configured to be removably fixed to the resin member or the terminal member, which is a part of the lid assembly.

7. The method of manufacturing a power storage device according to claim 4, wherein the shield member is made by bending a metal plate.

8. The method of manufacturing a power storage device according to claim 5, wherein the shield member is made by bending a metal plate.

9. The method of manufacturing a power storage device according to claim 6, wherein the shield member is made by bending a metal plate.
